(19) United States
(12) Patent Application Publication
(10) Pub. No.: US 2008/0295640 A1
(43) Pub. Date: Dec. 4, 2008

(54) Cover of Steering Wheel for Vehicle

(76) Inventors: Yuhua Wang, Beijing (CN); Lun Chai, Hong Kong (CN)

Correspondence Address: LADAS & PARRY, 5670 WILSHIRE BOULEVARD, SUITE 2100, LOS ANGELES, CA, 90036-5679, US

(21) Appl. No.: 11/631,276

(22) PCT Filed: Aug. 21, 2006
(86) PCT No.: PCT/CN06/02118

§ 371 Date: Dec. 28, 2006

(30) Foreign Application Priority Data
Nov. 23, 2005 (CN) 200520142123.5

(51) Int. Cl. B62D 1/06

(52) U.S. Cl. 74/558

(57) ABSTRACT

This invention relates to a cover of steering wheel. The main body of the cover is a sleeve (2) made of elastic rubber or soft thermoplastic materials. A coat (3) covering the sleeve (2) is made of textile materials or leather materials. The cover (1) is provided with a cut (4) at its circumference, and a pair of connecting and securing components (5) are mounted at the two ends of the cut (4) respectively for tightening and locking the two ends of the cut (4).

### TECHNICAL FIELD

The present invention relates to the cover of steering wheel for vehicle.

### BACKGROUND ART

Prior art cover of steering wheel is shown in FIG. 1. The main body of the prior art cover is a sleeve 2 made of elastic rubber or thermoplastic materials. A coat 3 covering the sleeve 2 is made of textile materials or leather materials. The prior art cover of steering wheel has such disadvantages as the diameter of the cover should accurately match the diameter of the steering wheel; no relative slippage is allowed between the cover and the steering wheel; and it is very strenuous to install the cover on the steering wheel.

### SUMMARY

The object of the present invention is to provide an improved cover of steering wheel for vehicle that overcomes the above disadvantages of the prior art cover of steering wheel.

The main body of the cover according the invention is a sleeve made of elastic rubber or soft thermoplastic materials. A coat covering the sleeve is made of textile materials or leather materials. The cover is provided with a cut, and a pair of connecting and securing components are mounted at the two ends of the cut respectively for tightening and locking the two ends of the cut.

The cut may be either a through cut or a non-through cut.

The connecting and securing components may be snapcloses made of soft thermoplastic materials.

The connecting and securing components may be made of metal materials.

The connecting and securing components may be a pair of nylon hook-and-loop tapes (also known as Velcro or magic tape) for tightening and locking.

There may be a tube enclosing the connecting and securing components.

There may be two tubes on the cover of steering wheel symmetrically, of which one encloses the connecting and securing components.

The cover of steering wheel for vehicle according to the invention solves the following problems: a relative slippage is present between the prior art cover and the steering wheel; and it is very strenuous to install the cover on the steering wheel.

### BRIEF DESCRIPTION OF THE DRAWINGS

FIG. 1 is a schematic view of the prior art cover of steering wheel.

FIG. 1A is a cross-sectional view along line A-A of FIG. 1.

FIG. 2 is a schematic view of the improved cover of steering wheel according to the invention.

FIG. 2B is a view in the direction of B-B of FIG. 2.

FIG. 3 is a schematic view of a tube used for enclosing the cut of the cover of steering wheel according to the invention.

FIG. 4 and FIG. 5 are schematic views of the improved cover of steering wheel according to the invention with cut being enclosed by the tube.

### DETAILED DESCRIPTION

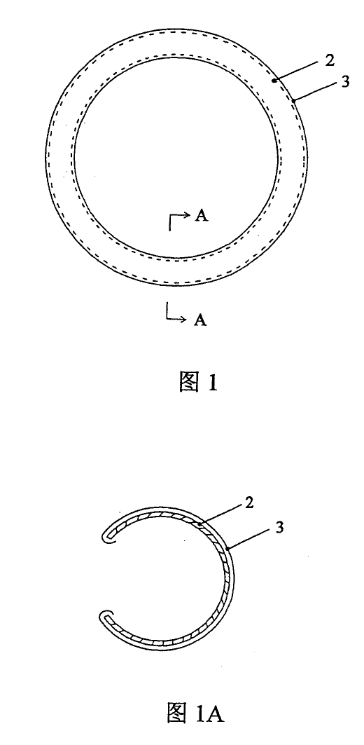

The sleeve 2 and the coat 3 of the prior art cover of steering wheel are shown in FIG. 1. FIG. 1A is a cross-sectional view along line A-A of FIG. 1.

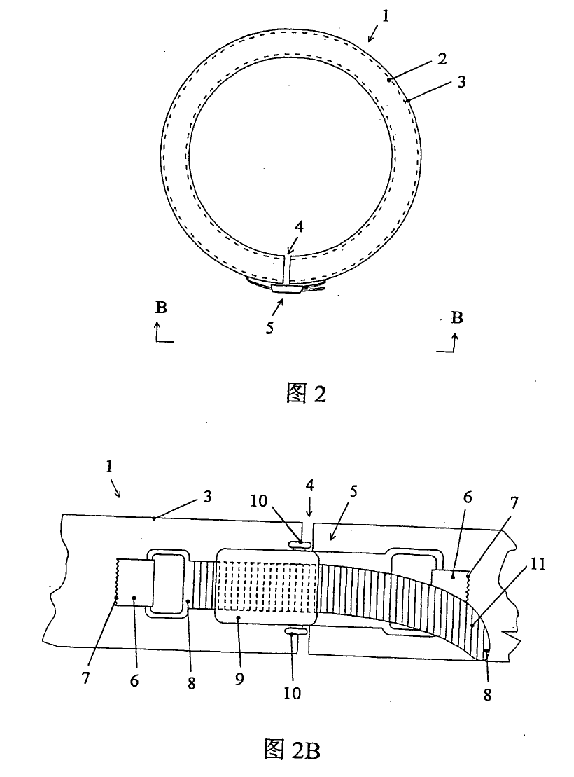

The improved cover of steering wheel 1 according to the invention is shown in FIG. 2. The sleeve 2 of cover 1 has a through cut 4 at its circumference, but the cut may also be a non-through cut (not shown). The sleeve 2 is made of elastic rubber, soft thermoplastic materials, or other rubbers, plastics, etc. A coat 3 covering the sleeve 2 is made of textile materials, leather materials, or rubbers, plastics, etc.

The coat 3 can be continuous or discontinuous (not shown) at the cut 4 of the sleeve 2. Thus, the cover 1 can open up freely so as to be installed on the steering wheel easily. FIG. 2B is a view in the direction of B-B of FIG. 2. A pair connecting and securing components such as snapcloses 5 are mounted at the both ends of the cut 4 respectively. By means of the snapcloses 5, the cover 1 is tightened so as to enclose the steering wheel tightly, and then the snapcloses 5 are locked so as to prevent the cover 1 from slipping back and loosing. The snapcloses 5 shown in FIG. 2B comprise two components 8 and 9 mounted at the two ends of the cut 4 respectively. Alternatively, the snapcloses 5 may comprise four or more components (not shown). Belts 6 go through the rings of components 8 and 9 respectively, and are secured in position at the two ends of the cut 4 respectively. The belts 6 can be made of textile, fabric, leather or other materials. The belts 6 can be secured by means of sewing, bonding and other conventional methods (not shown). The cut 4 is closed by pulling the component 8 through the component 9. A plurality of snap teeth (not shown) may be formed on the inner side of the component 9. A plurality of grooves may be formed on the component 8 to engage the snap teeth of component 9. The component 8 is snapped by the snap teeth of the component 9 during tightening of the cover 1 so as to prevent the cover 1 from slipping back and loosing. In this way, the cover 1 covers and encloses the steering wheel vehicle tightly, thus can't slip relative to the steering wheel. When the driver wants to remove the cover 1 from the steering wheel, he or she can press the button 10 to disengage the snap teeth from the grooves so that the component 8 can slip back, and then the cut 4 opens up and the cover 1 can be removed from the steering wheel. The button 10 can be provided with a selflock mechanism (not shown) to prevent the button 10 being pressed by accident.

The snapcloses 5 described above is only an example of the connecting and securing components of the invention. In practice, various connecting and securing mechanism used in waistbands, handbags, backpacks, trunks and the like can be used as the connecting and securing components of the invention. Alternatively, a pair of “magic tapes” (not shown) or nylon agraffes, elastic bands or other connecting and securing mechanisms can also be used as the connecting and securing components of the invention. The connecting and securing components of the invention can be made of plastics (for example, soft thermoplastic plastics or other plastics materials) or metals. The connecting and securing components can be secured by means of sewing, bonding, rivet bonding and other conventional methods (not shown).

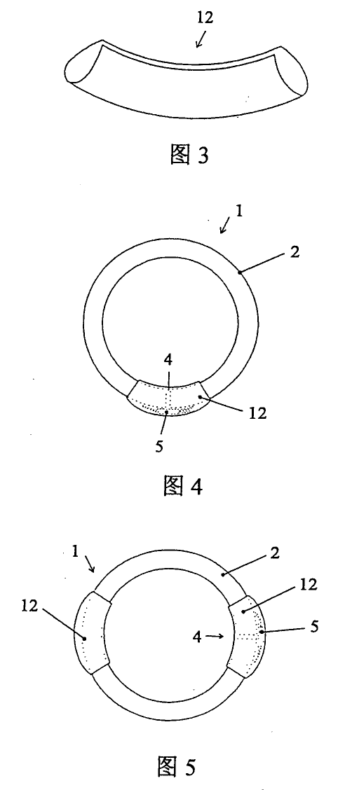

FIG. 3, FIG. 4 and FIG. 5 show the alternative embodiments of the cover of the invention. Specifically, FIG. 3 is a schematic view of a tube used for enclosing the cut of the cover 1 according to the invention. FIG. 4 and FIG. 5 are schematic views of the improved cover 1 according to the invention with the cut being enclosed by the tube. The snapcloses 5 may make the surface uneven and unsmooth, therefore, the drivers may feel uncomfortable. To solve this problem, an additional tube 12 (shown in FIG. 3) is provided to enclose the snapcloses 5. The tube 12 is made of elastic rubber or thermoplastic materials. The tube 12 has the same configuration and shape as those of the sleeve 2 except that the tube is not circular but a portion of a circle. The tube 12 can also be covered with textile or leather materials. As is shown in FIG. 4, a tube 12 encloses the snapcloses, thus making the surface of the cover 1 smooth. As is shown in FIG. 5, two short tubes 12 are provided symmetrically, of which one encloses the snapcloses 5. Therefore, the driver will have a better position feeling and symmetry feeling when holding the steering wheel.

What is claimed is:

1. A cover of steering wheel for vehicle (1), comprising:
a sleeve (2) which constitutes the main body of said cover (1) and is made of elastic rubber or soft thermoplastic materials;
a coat (3) which covers the sleeve (2) and is made of textile materials or leather materials,
wherein said cover (1) has a cut (4) at its circumference, and a pair of connecting and securing components (5) are mounted at the two ends of the cut (4) respectively for tightening and locking the two ends of the cut (4).

2. The cover according to claim 1, wherein said cut (4) is a through cut.

3. The cover according to claim 1, wherein said cut (4) is a non-through cut.

4. The cover according to claim 1, wherein said connecting and securing components (5) are made of plastics or metals.

5. The cover according to claim 1, wherein said connecting and securing components (5) are snapcloses.

6. The cover according to claim 1, wherein said connecting and securing components (5) are a pair of nylon hook-and-loop tapes.

7. The cover according to claim 1, wherein a tube (12) is provided at the position of said connecting and securing components (5).

8. The cover according to claim 1, wherein another tube is provided symmetrically to the tube (12) at the position of said connecting and securing components (5).
